(19) United States
(12) Patent Application Publication
(10) Pub. No.: US 2003/0066091 A1
(43) Pub. Date: Apr. 3, 2003

(54) Business models, methods, and apparatus for unlocking value-added services on the broadcast receivers

(75) Inventors: William Palmer Lord, Fishkill, NY (US); Andrew Vincent Marolda, Ossining, NY (US); Martin Rosner, Cortlandt Manor, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/970,756

(22) Filed: Oct. 3, 2001

(51) Int. Cl. H04N 11/00; G06F 3/00; H04N 5/445; G06F 13/00; H04N 7/16; H04N 7/00

(52) U.S. Cl. 725/135; 725/136; 348/460; 348/461; 348/465

(57) ABSTRACT

A system and method for enabling a consumer, in a television or audio broadcast environment, to access specific enhanced services, for example, interactive advertisements embedded in television programs, based on a contract between a product vendor and a video receiver manufacturer. The video receiver manufacturer is the TV or set-top box manufacturer, licensee or affiliated party. Purchasing transactions, including billing, are automatically managed by a data aggregator.

### BACKGROUND OF THE INVENTION

1. Field of the Invention

The present invention is directed to the field of broadcast television. It is particularly directed to facilitating desirable services related to television broadcasting.

3. Description of the Related Art

Widespread interactive television is becoming a reality as hardware and software have emerged for integrating television broadcasts with the World Wide Web. The consumer need no longer be a passive recipient of a particular television broadcast but can interact with the television to direct and select the flow of information to the consumer's set.

Until the development of this new technology, television advertisements required a consumer to physically leave the consumer's television set and/or make a telephone call to order an advertised product. The prior art describes a device for facilitating this process.

International Publication Number WO 96/25006 entitled Interactive Broadcasting System describes a system for facilitating ordering and paying for products, advertised on television, that a consumer wishes to purchase. Consumers use a messaging device for automatically dialing a vendor and transmitting an identification code, method of payment, and item to be ordered.

Today, however, the need to place a telephone call has been obviated. A variety of television enhancement devices, including Web TV® and so-called set-top boxes from a variety of vendors, including Philips Electronics, enable the consumer to interact directly with the television, by providing the necessary digital processing capability and communications link. Information ancillary to a particular television program, for example a link to a web page to purchase an advertised product, is combined with a digital or analog television signal, or may be processed as part of the television signal. The consumer is able to select a web page link, using a remote control for example, and make an immediate purchase.

Today, consumers and vendors are interested in additional services beyond just the ability to make a purchase. What is necessary is a mechanism for limiting access to a variety of services, to authorized users, as well a means for protecting the privacy of service subscribers.

International Publication Number WO 98/00972 entitled Method and Apparatus for Operating a Transactional Server in a Proprietary Database Environment describes a system for protecting the confidentiality of subscriber information. When a subscriber initiates a request for information from an information provider, a transaction server submits the request along with the subscriber identification in encrypted form. When the information provider responds with the requested information, a database server decrypts the encrypted identification so that the information can be routed to the subscriber. This invention only addresses a limited aspect of facilitating interactive consumer purchases. In addition, it only concerns accesses to data stored on a database server, and 10, does not protect other resources such as memory, disk, printer, CPU, and other system components.

It has also been known that the video receiver manufacturer typically sells a single video receiver to a consumer for a certain sum. There are usually very low margins on most video receiver devices but a very large revenue stream to the broadcaster for the services provided by the broadcaster.

What is needed is a comprehensive system, method, and computer-executable process steps for providing access to specific value-added services in the television and audio broadcast environment. In particular, a model is needed for providing those services in an efficient and secure manner that benefits both the consumer, product vendors, and the intermediary supplying the enhanced services.

### SUMMARY OF THE INVENTION

The present invention addresses the foregoing need by providing a system, (i.e, a method, an apparatus, and computer-executable process steps), for enabling a consumer, in a television or audio broadcast environment, to access specific enhanced services based on a contract between a product vendor and video receiver manufacturer rather than the product manufacturer contracting with the broadcaster only. The video receiver manufacturer, hereinafter receiver manufacturer, may make the receivers itself or contract to have them made by a third party, but that third party is not the provider of the broadcast stream.

Enhanced services, also known as value-added services, benefit both the consumer and the vendor. These services include for example, interactive advertisements embedded in television programs, on-screen prompting for communicating between consumer and vendor, development of user profile information which is associated with purchasing information yielding marketing information, electronic cash, vendor coupons, loyalty programs, and bookmarking of favorite vendors. These services may be provided using a set-top box connected to a display and/or other devices such as a printer, audio player, smart card reader or personal digital assistant (PDA), for example.

In the present invention, only enhanced services which are broadcast for vendors contracting with the video receiver manufacturer will be able to be executed. Contracting vendors are authorized via a digital certificate, issued by the receiver manufacturer or sanctioned certificate authority, which the vendor submits to be transmitted along with the enhanced service. The digital certificate also ensures that the content of the enhanced service is not altered after the vendor broadcasts it. The video receiver will only provide the enhanced services if a valid certificate is received.

One example of an enhanced service enables the consumer to purchase advertised goods by interacting with the television program being viewed, via a remote control, without the necessity for making a telephone call. User profile information, such as credit card number, protected by security measures, is made automatically available, thereby reducing the need for data input by the consumer.

Purchasing transactions, including billing, are automatically managed by a data aggregator. A data aggregator receives the purchasing information generated by the consumer and establishes communications with the vendor or its processing systems to complete the purchase transaction. The data aggregator maintains specific product and purchase information, as well as correlated data regarding the consumer's demographics and profile information. The data aggregator also maintains a log of all purchases, and tracks them, facilitating production of analytical reports which reflect advertisement effectiveness and enable the vendor to target specific consumer segments for each advertisement. The data aggregator maintains user profiles via a back channel.

This brief summary has been provided so that the nature of the invention will be understood quickly. A more complete understanding of the invention is obtained by reference to the following detailed description of the preferred embodiments thereof in connection with the attached drawings.

### BRIEF DESCRIPTION OF THE DRAWINGS

FIG. 1 depicts a system on which the present invention is implemented.

FIG. 2 is a flow diagram, which illustrates how an enhanced service is delivered.

### DETAILED DESCRIPTION OF THE PREFERRED EMBODIMENTS

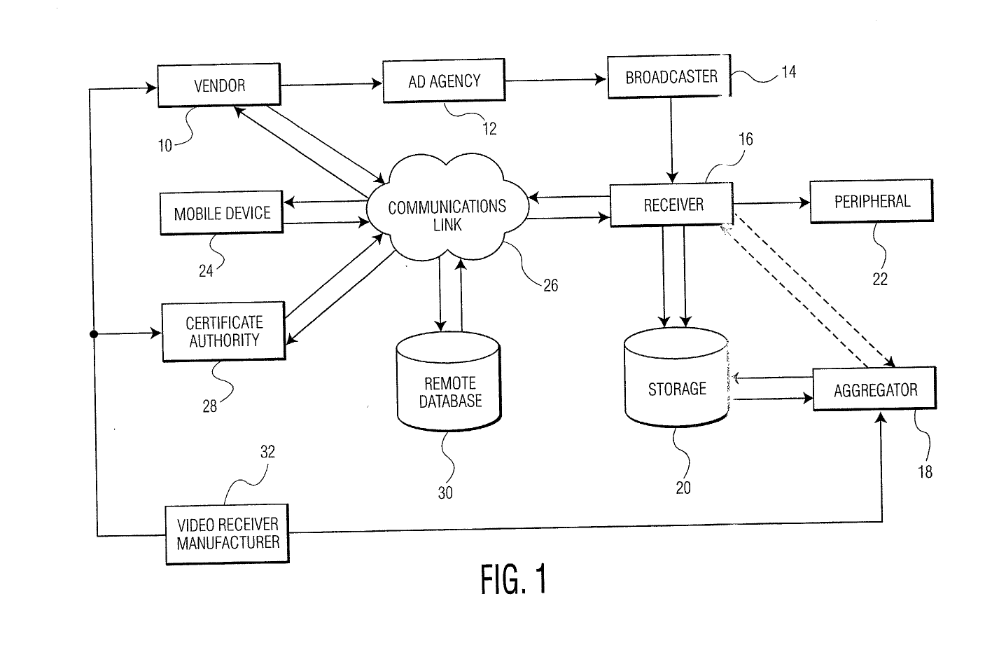

FIG. 1 shows a representative embodiment of a system on which the present invention is implemented. In this embodiment, a vendor 10 communicates with an advertising agency 12, requesting a product advertisement and optionally providing data to be embedded within the advertisement, which will provide enhanced services. These enhanced services may also be designed by the advertising agency. Enhanced services include product-specific and commerce-enabling data elements, which can be incorporated within a television content broadcast stream. The broadcast stream may utilize a number of different delivery methods including but not limited to terrestrial signal broadcast, direct satellite broadcast, CATV broadcast, POTS transmission, digital subscriber line transmission, and two-way cable transmission.

Such enhanced services conform to industry-wide content standards such as the Digital TV Application Software Environment (DASE), Advanced Television Enhancement Forum Specification for Interactive Television (ATVEF), or other standards established by the Advanced Television Systems Committee (ATSC) or to proprietary data and delivery formats established by a set-top box vendor. Such services include, for example, supplying an “electronic wallet” to the consumer. The Aggregator 18 stores monetary credit for the consumer, which can be used towards enhanced purchase offers. The consumer pays the Aggregator 18 in advance and is given credit to use in transactions conducted through the Receiver 16.

Embedded discount coupons constitute another enhanced service for the consumer who might make a subsequent purchase from the same vendor. Triggers in the data stream or the user profile alert the consumer the next time the advertisement airs, that a discount coupon is now available to the consumer. The Vendor 10 stores discount coupons in a user profile, which is stored in Storage 20, in the memory of the Receiver 16, or at a remote location.

Data markers, which are similar to bookmarks which can be established in Internet browsers, enable the consumer to mark enhanced data embedded in the television content stream, for storage in the user profile. The consumer can then view the data at any time that is convenient.

User profile services offer consumers and vendors a data module which stores items such as vendor coupons, for which a rental fee is charged, World Wide Web links, bookmarks, PIN codes for family purchase management, and transaction history and data reports for consumer financial planning.

Data triggers, embodied in the broadcast advertisement enable a vendor to deliver differentiated data to a consumer by interacting with the consumer's user profile information. For example, tiered pricing of products is established based upon the demographics or preferences of the consumer household. A household of teenagers will receive discounted prices for teen products.

Still another enhanced service permits consumers to participate in loyalty programs. Consumers register for the programs and receive viewing points for watching their favorite programs. Vendors and providers of program content also benefit from this service. Content creators can track loyal viewer registration statistics, cross-sell additional content, and specifically target their content and advertisements to loyal viewers. Loyal viewers receive prizes, rewards, and additional products or services when they accumulate predetermined point accumulations. The user profile is used to track the number of points accumulated by each consumer and to direct specific content or embedded data to consumer loyalty program participants.

The system optionally includes a mobile device 24 such as a remote audio receiver, radio, or cell phone, which communicates with the Receiver 16 via the communications link 26. In this way, enhanced services may be delivered to a consumer in his or her car, for example. If a third party, other than the receiver manufacturer 32, vendor 10, or ad agency 12 is the provider of the mobile device 24, the receiver manufacturer 32 charges the third-party a fee. This can be a blanket usage fee or a per use fee.

Providers of the Peripheral 22 are also charged a fee. The peripheral is a printer accessory, memory storage, PDA, audio player, DVD player, video tablet, smart card or other related electronic or computing device which can be directly integrated with the Receiver 16 or connected to it via cables, cradles, or wireless means. The Peripheral 22 is used to provide the consumer with enhanced services as described in the following examples. If the Peripheral 22 is memory, the service provided is caching web pages on behalf of e-commerce and content providers. If the Peripheral 22 is a printing device, the service provided is instant printing of digital coupons, flyers or other promotional or information material received. If the Peripheral 22 is a PDA or smart card, the service provided is delivering digital discounts, promotions, or associated data to the device. If the Peripheral 22 is an integrated multimedia player component or related electronic device, the service provided is downloading digital music or multimedia data. In addition, providing access to resources such as additional memory, printers, screen real-estate, and CPU cycles are in and of themselves enhanced services which can be provided by the receiver manufacturer.

The advertisement, along with the embedded data enabling enhanced services is transmitted to the Broadcaster 14 along with a digital certificate, which has been issued by the receiver manufacturer 16 to the Vendor 10. The digital certificate identifies the vendor as a party which has contracted with the entity manufacturing, licensing, or selling the Receiver 16 to provide enhanced services to the consumer operating the Receiver 16. It should be noted that the direct contractual relationship exists between the manufacturer or entity selling the Receiver 16 rather than between the Broadcaster 14 and the Vendor 10. It also ensures that the advertisement belongs to the vendor and provides data integrity for the advertising content. The Certificate Authority 28 is responsible for maintaining a list of valid certificates and associated vendors and for revoking certificates in the case of a vendor contract breach, expiration, or a security risk. The certificates may be stored remotely in a Remote Database 30 accessible via the Communications Link 26 or in the Receiver 16. The Receiver 16 may be a set-top box or a smart television receiver, for example. Together, the Vendor 10, Advertising Agency 12, Broadcaster 14, Receiver 16, and Aggregator 18 form a value chain for adding value to the regular television broadcast and transmitting this added value to a Receiver 16 where the consumer can interact with the services provided. In this case, the Receiver Manufacturer 32 receives a percentage of the revenue stream by contracting directly with the Vendor 10 and maintaining control over whether its purchasers will be able to view and/or interact with the Vendor's 10 enhanced services. Additional revenue may be also be generated by auxiliary services such as data aggregation.

In some instances, the enhanced services are not embedded in the broadcast stream but instead, embedded in the media of an attached peripheral 22. For example, an enhanced service can be embedded in a VHS tape's analog content using the vertical blanking interval (VBI) or in a DVD's content. As another example, the enhanced services can be transmitted via a 2-way channel such as the Internet 26 to a television receiver, networked PC, or set top box 16.

In each case, whether the content is broadcasted, networked, or embedded in a DVD or VHS tape, the content is a multiplex of audio, video, data and computer programs. Each medium has its own method of encoding this multiplex of content. The television receiver or set top box has the capability to interpret or execute computer programming languages such as Java, JavaScript, HTML, XML, and others. These programs can access resources on the television receiver. when granted access rights by the receiver manufacturer. So for example, a DVD would play out multiplexed content received from the television receiver. In another way, the processing capability could be located in the DVD player and the television would act as a monitor.

When the consumer makes a purchase, a user profile is created and/or updated. The user profile is an independent data module resident either in the memory of the Receiver 16 or at a remote location. Certain portions of the user profile can be updated by the user or by the Receiver Manufacturer 32.

The user profile contains information, which is delivered automatically to a purchase application. This information reduces the entry time and effort for the consumer to consummate the transaction as it includes credit card information, address information, telephone information and other purchase-related information. The user need no longer enter this information for each purchase. The user profile also contains local security measures including personal identification numbers (PIN) for household user identification and purchase monitoring. The user profile and/or updates are transmitted by the purchase application via a back channel to the Aggregator 18.

The Aggregator 18 is an entity which is managed by the Receiver Manufacturer 32 or its representative. Upon receiving the purchase information from the Receiver 16, it establishes communications with the Vendor via the Communications Link 26 or a separate communications path, to complete the purchasing transaction. The Aggregator 18 serves as the intermediary between the processing system of the Vendor 10 and the Receiver 16. The Vendor and Aggregator 18 exchange order fulfillment information such as product availability, payment verification, address verification, tax and shipping calculations and order confirmation. In one embodiment, the Aggregator 18 takes on some of the order fulfillment functions of the Vendor 10 such as calculating shipping, tracking shipping, and confirming orders, for example. The result is an executed purchase transaction with a confirmation transmitted to both the Aggregator 18 and the consumer via the Receiver 16.

The Aggregator 18 is also a repository of purchasing information and user information which can be associated and analyzed. The Aggregator 18 maintains a log of all purchases made by a consumer via the Receiver 16 including specific product and purchase information. These data are associated with consumer profile and demographic information for each purchase. On a periodic basis, the Aggregator 18 applies various analyses and data-mining techniques to the accumulated current and historical data, generating specialized reports. These reports are transmitted to the partner vendors to aid the vendors in determining advertisement effectiveness and to assist them in improving their ability to target specific consumer segments.

The Aggregator 18 is responsible for vendor billing. Depending upon the revenue arrangement established in the vendor contract, the Aggregator 18 will accumulate the number of confirmed transactions effected by utilizing data stored in the user profile or from a log of additional services provided by the Receiver Manufacturer 32. Billing information is batch processed and periodic invoices for billable services are delivered to the partner vendors. Only confirmed and completed transactions are billed.

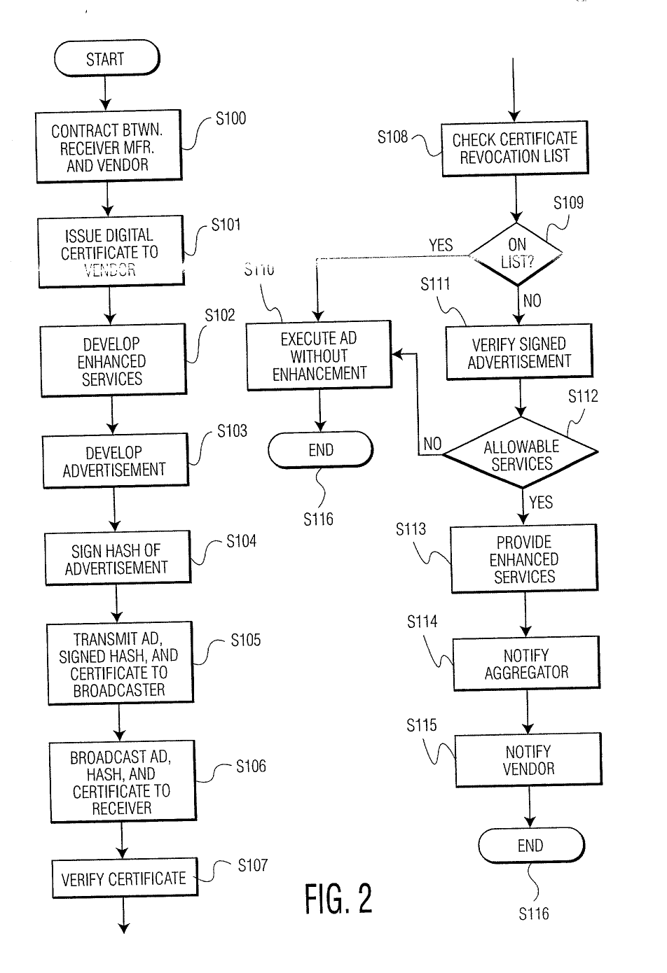

FIG. 2 illustrates how an enhanced service is delivered. To start, in the preferred embodiment, after the Receiver Manufacturer 32 and the Vendor 10 contract, a digital certificate is issued offline to a vendor in step S101, by the Receiver Manufacturer 32, or a Certificate Authority 28, managed by the Receiver Manufacturer 32. As is well known in the art, a certificate is an electronic document used to identify an entity and to associate that entity with a public key. The certificate includes at a minimum, (1) a public key assigned to the vendor, (2) a vendor identification, (3) an expiration date, (4) a list of value added services unlocked by the certificate, and (5) a digital signature consisting of a hash of items 1-4 signed with a private key of a Certificate Authority. The receiver Certificate Authority also issues a digital certificate to itself, which identifies updating the certificate revocation list as a specific value-added service. This means that the private key of the receiver Certificate Authority does not have to be stored on a computer connected to any network.

Data encrypted with the public key can be decrypted only with the private key. Therefore, the public key can be distributed widely but the private key must be kept secure.

Alternatively, a digital certificate is not issued immediately to the vendor. Instead, only the public key is initially issued. The receiver Certificate Authority only issues the certificate when the vendor successfully responds to a challenge-response interaction, as is well known in the art, that confirms that the Vendor has the private portion of the key. For example, the Vendor might be required to decrypt a message encrypted with the public key.

The next step is to develop enhanced services step S102. These may be developed by the Vendor or by the advertising agency. If the agency develops the advertisement, the Vendor provides the requirements, and then the agency develops the ad in step S103 and sends it back to the Vendor, which inspects and verifies the ad. In either case, the Vendor “signs” a hash of the advertisement in step S104 using the private key the Vendor received in step S101 and forwards the ad, signed hash, and certificate to the Broadcaster in step S105.

As is well known in the art, it possible to use a private key to generate a signature and a public key to verify a signature. This is a crucial part of digitally signing any data. Instead of encrypting the data, the signing software creates a one-way hash of the data. A one-way hash is also known as a message digest. It consists of data of a fixed length with the following characteristics: 1) the value of the hash is unique to the hashed data. Any change in the data, even the deletion of single character will result in a different hash; and 2) the content of the hashed data cannot be deduced from the hash which is why it is called one-way. The signed hash, along with other information such as the hashing algorithm and the public key of the signatory is known as the digital signature. In step S106, the ad, hash, and certificate are broadcast by the broadcaster to the Receiver.

In step S107, the Vendor's name is checked by the Receiver Certificate Authority to verify that the Vendor has been issued a certificate. In step S108 the certification revocation list is checked to ensure that a Vendor's certificate has not been revoked. Several circumstances dictate that the certificate must be revoked. For example, if the private key becomes public knowledge or two Vendors present identical public private key pairs to the receiver Certificate Authority, the certificate has been compromised. Compromise of a private key affects only a particular contract between the Receiver Manufacturer and the Vendor. The certificate is also revoked when there is a breach of contract between the Receiver Manufacturer and the Vendor.

The certificate revocation list may be maintained in a remote database so that up-to-date information is available online. Alternatively the certificate revocation list may be maintained in the Receiver and updated through a broadcast message. If a certificate appears on the revocation list, when checked in step S109, the enhanced services are not displayed but rather the regular television broadcast is displayed in step S110.

In step S111, the signed advertisement is verified using the public key contained within the certificate. To validate the integrity of the data received, the receiving software first uses the public key of the certificate authority to verify the identity of the Vendor and its associated public key. It then uses the Vendor's public key to decrypt the hash. It then uses the same hashing algorithm that generated the original hash to generate a new one-way hash of the same data. The new hash is compared against the original. If the two hashes match, the data has not changed since it was signed. The recipient can also be certain that the public key used to verify the digital signature corresponds to the private key used to create the digital signature. The identity of the signer, has already been verified by reference to the certificate list in step S107, confirming that the public key really belongs to a particular Vendor. The digital certificate also contains a list of services that the Vendor is allowed to execute. The service provided by the current advertisement is checked in step S112 against the allowable services listed in the Vendor's certificate.

If the signed advertisement is successfully verified in step S111 and step S112 the enhanced services are then executed in step S113. When a purchase is made, the data aggregator is notified in step S114. The Aggregator notifies the Vendor, periodically, in step S115, as to the details of purchases made as a result of the enhanced services.

Although this method has been described with respect to a purchasing transaction, implementing other value-added services follow the same model. For example, adding new value-added services, which requires access to the hardware that reprograms portions of the Receiver, is only permitted when a digital certificate which lists “upgrade value-added services” as an unlocked service is validated in step S112.

The present invention has been described with respect to particular illustrative embodiments. It is to be understood that the invention is not limited to the above-described embodiments and modifications thereto, and that various changes and modifications may be made by those of ordinary skill in the art without departing from the spirit and scope of the appended claims.

What is claimed is:

1. A method for providing enhanced services to a vendor and a consumer, wherein a video receiver manufacturer contracts with the vendor to provide the enhanced services, comprising the steps of:
receiving in a video receiver embedded data providing the enhanced services within a television broadcast stream;
executing the embedded data at the video receiver, such that a consumer receives the enhanced services, only if the vendor is authorized by the video receiver manufacturer via a direct relationship between the video receiver manufacturer and the vendor;
generating a purchasing request, as a result of the consumer interacting with the enhanced services.

2. The method according to claim 1, further including the step of transmitting the purchasing request from the video receiver, to a vendor of a product requested in the purchasing request, so that the purchasing request can be fulfilled.

3. The method according to claim 2, wherein the purchasing request is first transmitted from the receiver to an aggregator and then to the vendor.

4. The method according to claim 1, wherein a broadcaster transmits the embedded data providing the enhanced services, within a television broadcast stream, to the receiver.

5. The method according to claim 1 wherein the receiver is an element of a personal computer system.

6. The method according to claim 1, further including the step of storing a user profile for each consumer.

7. The method according to claim 6, wherein each user profile is maintained by an aggregator.

8. A method according to claim 7, wherein the aggregator maintains a log of all purchases and associates the relevant user profile with each purchase.

9. The method according to claim 1, wherein the vendor embeds the data providing the enhanced services within an advertisement which is transmitted within the television broadcast stream.

10. The method according to claim 1, wherein an advertiser embeds the data providing the enhanced services within an advertisement which is transmitted within the television broadcast stream.

11. The method according to claim 6, wherein user profile information is manually input by the consumer receiving the enhanced services.

12. The method according to claim 1, wherein the receiver is a set-top box.

13. The method according to claim 1, wherein the receiver is a television display with a processor.

14. The method according to claim 3, wherein the receiver communicates with the aggregator via a back channel.

15. The method according to claim 1, wherein the video receiver manufacturer charges a commission for providing the enhanced services to the vendor and the consumer, the commission being based upon a dollar amount of purchases generated by the consumer.

16. The method according to claim 1, wherein a certificate authority issues digital certificates and maintains a list of revoked digital certificates, for authorizing the vendor and the execution of the enhanced services at the video receiver.

17. The method according to claim 16 wherein each digital certificate comprises at least (1) a public key assigned to the vendor, (2) a vendor identification, (3) an expiration date, (4) a list of value added services unlocked by the certificate, and (5) a hash of items 1-4 signed with a private key of the certificate authority.

18. The method according to claim 16, wherein the certificate authority revokes the digital certificate when there is a breach of contract between the vendor and the video receiver manufacturer, or a private key of the vendor becomes known to any party, other than the vendor.

19. The method according to claim 1, further including the step of enabling the video receiver to execute new enhanced services, by reprogramming portions of the video receiver, when a digital certificate which lists an upgrade service as an allowable service, is validated

20. A video receiver system for providing enhanced services to a consumer, offered by a vendor and facilitated by a manufacturer of a video receiver, comprising:
a video receiver for executing the enhanced services which are contained in a video broadcast stream only when the vendor is authorized by the video receiver manufacturer via a client relationship between the video receiver manufacturer and the vendor, and generating any purchasing request, initiated as a result of the consumer interacting with the enhanced services.

21. The video receiver system as in claim 20, wherein a broadcaster transmits the enhanced services, within an advertisement to the receiver.

22. The video receiver system as in claim 21, wherein the vendor transmits the enhanced services, within an advertisement, to the broadcaster, prior to transmission to the receiver.

23. The video receiver system as in claim 20 wherein the receiver includes an interactive device, used by the consumer, for interacting with the enhanced services provided by the receiver.

24. The video receiver system as in claim 21, wherein an aggregator communicates with the video receiver and aggregates any purchase requests made by the consumer in response to the advertisement.

25. The video receiver system as in claim 24, wherein the aggregator communicates with the video receiver via a back channel.

26. The video receiver system as in claim 20, wherein the aggregator transmits any purchasing request to the vendor of a product requested in the purchasing request, so that the purchasing request can be fulfilled.

27. The video receiver system as in claim 20, wherein the video receiver is a set-top box.

28. The video receiver system as in claim 20, wherein the video receiver is a television with a processor.

29. The video receiver system as in claim 20, wherein the video receiver is an element of a personal computing system.

30. The video receiver system as in claim 20, wherein the video receiver is connected to a peripheral for delivering products and services to the consumer.

31. The system as in claim 20, wherein the video receiver communicates bidirectionally with a mobile device in order to deliver products and services to the consumer.

32. The video receiver system as in claim 20, wherein digital certificates are issued to authorized vendors, in order to verify that a vendor has contracted for at least one of the enhanced services, prior to reception of the at least one enhanced service by the video receiver.

33. The video receiver system as in claim 32, wherein a certificate authority maintains a list of the digital certificates.

34. The video receiver system as in claim 33, wherein the list of digital certificates is stored in a remote database.

35. The video receiver system as in claim 32, wherein the video receiver maintains a list of the digital certificates, the list of digital certificates being stored within the receiver, and being updated in response to a broadcast message specifying addition, modification, or deletion therefrom.

36. The video receiver system as in claim 32, wherein the vendor signs the hash value of an advertisement containing at least one the enhanced services.

37. The video receiver system as in claim 32, wherein the digital certificate comprises at least (1) a public key assigned to the vendor, (2) a vendor identification, (3) an expiration date, (4) a list of value added services unlocked by the certificate, and (5) a hash of items 1-4 signed with a private key of a certificate authority.

38. The video receiver system as in claim 24, wherein the aggregator performs order-fulfillment functions on behalf of the vendor.

39. Computer-executable process steps stored on a computer-readable medium providing enhanced services to a consumer, the services being offered by a vendor and facilitated by a video receiver manufacturer, comprising:
a receiving step wherein the video receiver receives enhanced services, within a television broadcast stream;
an executing step wherein the video receiver executes the enhanced services at the video receiver, such that a consumer receives the enhanced services, only if the vendor is authorized by the video receiver manufacturer via a direct relationship between the video receiver manufacturer and the vendor; and
a purchasing request generating step, wherein the video receiver generates a purchasing request as a result of the consumer interacting with the enhanced services.

40. Computer-executable process steps as in claim 39, further including an authorization step wherein digital certificates are issued to authorize vendors, in order to verify that a vendor has contracted with the video receiver manufacturer for the enhanced services, and a list of the revoked digital certificates is maintained and referenced to ensure that enhanced services are only provided on behalf of the authorized vendors.

41. Computer-executable process steps as in claim 40, further including a signing step wherein the vendor signs a hash value of an advertisement containing at least one of the enhanced services.

42. Computer-executable process steps as in claim 41, further including a transmission step wherein a broadcaster transmits the enhanced services within an advertisement, along with a signed hash value of the advertisement containing at least one of the enhanced services, and a digital certificate issued to the vendor, by a certificate authority, to the receiver.

43. Computer-executable process steps as in claim 39, further including a development step wherein the vendor develops the enhanced services.

44. Computer-executable process steps as in claim 39, further including a development step wherein an advertising agency develops the enhanced services.

45. Computer-executable process steps as in claim 39, further including an aggregation step wherein an aggregator aggregates any purchasing requests and transmits each purchasing request to the appropriate vendor.

46. A system for providing enhanced services to a consumer, the services being offered by a vendor and facilitated by a television receiver manufacturer, comprising:
means for authorizing a television receiver to execute specific enhanced services on behalf of the vendor; and
television receiver means for executing the enhanced services which are contained in a video broadcast stream only when the vendor is authorized by the television receiver manufacturer in a client relationship between the television receiver manufacturer and the vendor, and generating any purchasing request, initiated as a result of the consumer interacting with the enhanced services.

47. The system as in claim 46, further including validation means for validating that the authorization has not been revoked.

48. The system as in claim 46, further including means for developing an advertisement in which the enhanced services are embedded.

49. The system as in claim 46, further including means for developing the enhanced services.

50. The system as in claim 46, further including first notification means for notifying an aggregator of any purchases made via the enhanced services.

51. The system as in claim 50, further including second notification means by which the aggregator notifies the vendor of any purchases to be fulfilled by the vendor.

52. The system as in claim 48, further including means for transmitting the advertisement and the authorization to a broadcaster.

53. The system as in claim 48, further including means for transmitting the advertisement and the authorization from a broadcaster to the video receiver.

54. The system as in claim 48, further including a first verification means for verifying that the authorization and the advertisement originated with an authorized vendor.

55. The system as in claim 46, further including revocation means for revoking an invalid authorization.

56. The system as in claim 54, further including a second verification means for verifying the data integrity of the advertisement.

57. The system as in claim 46, wherein the authorization means is a signed hash value of an advertisement containing at least one of the enhanced services.

58. A method of doing business by a video receiver manufacturer comprising:
contracting directly with a vendor to sell the vendor's enhanced services through the video receivers of the video receiver manufacturer;
providing video receivers to consumers with the enhanced services of the vendor having a contractual relationship with the video receiver manufacturer; and
generating purchase requests, initiated as a result of the consumer interacting with the enhanced services.

59. The method as in claim 58 wherein a broadcaster transmits the enhanced services to the video receiver.

60. The method as in claim 58 wherein an aggregator communicates with the video receiver and aggregates any purchase requests made by the consumer in response to the enhanced services.

61. The method as in claim 58 wherein the contractual relationship with the video receiver manufacturer is verified prior to displaying the enhanced services.

62. A method of doing business by a vendor comprising:
contracting directly with a video receiver manufacturer, the video receiver manufacturer having the obligation to:
i. sell the vendor's enhanced services through the video receivers of the video receiver manufacturer;
ii. provide video receivers to consumers with the enhanced services of the vendor having a contractual relationship with the video receiver manufacturer; and
iii. generate purchase requests, initiated as a result of the consumer interacting with the enhanced services.

63. A method of doing business by an advertiser comprising:
contracting directly with a video receiver manufacturer and a vendor, the video receiver manufacturer having an obligation to:
i. sell the vendor's enhanced services through the video receivers of the video receiver manufacturer;
ii. provide video receivers to consumers with the enhanced services of the vendor having a contractual relationship with the video receiver manufacturer; and
iii. generate purchase requests, initiated as a result of the consumer interacting with the enhanced services; and
the advertiser having a responsibility to embed an enhanced service for promoting products of the vendor within a video stream for transmittal to the video receiver.

64. A video receiver system for providing enhanced services to a consumer, offered by a vendor and facilitated by a manufacturer of a video receiver, comprising:
a peripheral device in communication with a video receiver for executing the enhanced services which are stored on the peripheral device only when the vendor is authorized by the video receiver manufacturer via a client relationship between the video receiver manufacturer and the vendor, and generating any purchasing request, initiated as a result of the consumer interacting with the enhanced services.

65. The system as in claim 64, wherein the peripheral device is a digital video disk player.

66. The system as in claim 64, wherein the peripheral device is a video tape recorder.

67. A method for providing enhanced services to a vendor and a consumer, wherein a video receiver manufacturer contracts with the vendor to provide the enhanced services, comprising the steps of:
receiving in a video receiver, connected via a two-way channel to the Internet, embedded data within a network data stream, providing the enhanced services;
executing the embedded data at the video receiver, such that a consumer receives the enhanced services, only if the vendor is authorized by the video receiver manufacturer via a direct relationship between the video receiver manufacturer and the vendor;
generating a purchasing request, as a result of the consumer interacting with the enhanced services.
